(19) United States
(12) Patent Application Publication
(10) Pub. No.: US 2004/0135746 A1
(43) Pub. Date: Jul. 15, 2004

(54) Apparatus and methods for driving a plasma display panel

(75) Inventors: Jun-Young Lee, Cheonan-city (KR); Hak-Ki Choi, Cheonan-city (KR)

Correspondence Address: McGuireWoods LLP, Tysons Corner, Suite 1800, 1750 Tysons Boulevard, McLean, VA, 22102-4215, US

(73) Assignee: Samsung SDI Co., Ltd.

(21) Appl. No.: 10/610,873

(22) Filed: Jul. 2, 2003

(30) Foreign Application Priority Data
Jul. 2, 2002 (KR) 2002-0037897

(51) Int. Cl. G09G 3/28

(52) U.S. Cl. 345/60

(57) ABSTRACT

In an apparatus for driving a plasma display panel, first and second switches are coupled in series between a power source Vₛ and one terminal of a panel capacitor. Third and fourth switches are coupled in series between the one terminal of the panel capacitor and a power source −Vₛ. A contact of the first and second switches is coupled to a ground terminal while the one terminal of the panel capacitor is substantially fixed to a voltage of −Vₛ. A contact of the third and fourth switches is coupled to the ground terminal while the one terminal of the panel capacitor is substantially fixed to a voltage of Vₛ. Then, the withstand voltages of the first and second switches can be clamped to Vₛ while the voltage of −Vₛ is applied to the one terminal of the panel capacitor. Likewise, the withstand voltages of the third and fourth switches can be clamped to Vₛ while the voltage of Vₛ is applied to the one terminal of the panel capacitor.

### CROSS REFERENCE TO RELATED APPLICATION

This application is based on Korean Patent Application No. 2002-0037897 filed on Jul. 2, 2002. The content of the Application is fully incorporated by reference herein.

### BACKGROUND OF THE INVENTION

1. Field of the Invention

The present invention relates to apparatus and methods for driving a plasma display panel (PDP).

2. Description of the Related Art

In recent years, flat panel displays such as liquid crystal displays (LCDs), field emission displays (FEDs), PDPs, and the like have been actively developed. PDPs are advantageous over other flat panel displays by providing high luminance, high luminous efficiency and wide view angles. Accordingly, PDPs are favorable as substitutes for conventional cathode ray tubes (CRT) for making large-scale screens of 40 inches or more.

A PDP is a flat panel display, that uses plasma generated by gas discharge, to display characters or images, and it includes, according to its size, more than several scores to millions of pixels arranged in a matrix pattern. Such a PDP is classified as a direct current (DC) type or an alternating current (AC) type according to the PDP's discharge cell structure and the waveform of the driving voltage applied thereto.

DC PDPs have electrodes exposed to a discharge space, allowing a direct current to flow through the discharge space while voltage is applied. Thus, for DC PDPs, resistors are used to limit the current. In contrast, AC PDPs have electrodes covered with a dielectric layer that naturally forms a capacitance component that limits the current and protects the electrodes from the impact of ions during a discharge. Thus, AC PDPs have longer lifetimes.

Typically, a driving method of AC PDPs is sequentially composed of a reset step, an addressing step, a sustain discharge step, and an erase step.

In the reset step, the state of each cell is initialized in order to readily perform an addressing operation on the cell. In the addressing step, wall charges are accumulated on selected “on”-state cells and other “on”-state cells (i.e., addressed cells) for selecting “off”-state cells on the panel. In the sustain discharge step, a sustain pulse is applied alternately to scan electrodes (hereinafter referred to as “Y electrodes”) and sustain electrodes (hereinafter, referred to as “X electrodes”) to perform a discharge for displaying an image on addressed cells.

In AC PDPs, the Y and X electrodes for such a sustain discharge act as a capacitive load, and a capacitance exists for the Y and X electrodes (hereinafter referred to as a “panel capacitor Cₚ”).

Now, a description will be given as to a driver circuit for a conventional AC type PDP and its driving method.

FIG. 1 illustrates a conventional driver circuit and FIG. 2 illustrates an operating waveform of the conventional driver circuit illustrated in FIG. 1.

The driver circuit generating a sustain pulse, as suggested by Kishi et al. (Japanese Patent No. 3201603), comprises, as shown in FIG. 1, a Y electrode driver 11, an X electrode driver 12, a Y electrode power supplier 13, and an X electrode power supplier 14. The X electrode driver 12 and the X electrode power supplier 14 are the same in construction as the Y electrode driver 11 and the Y electrode power supplier 13, and will not be described in detail in the following description.

The Y electrode power supplier 13 comprises a capacitor C₁, and three switches SW₁, SW₂, and SW₃. The Y electrode driver 11 comprises two switches SW₄ and SW₅. The switches SW₁ and SW₂ in the Y electrode power supplier 13 are coupled in series between a power source Vₛ and a ground voltage GND. One terminal of the capacitor C₁ is coupled to the contact of the switches SW₁ and SW₂, and the switch SW₃ is coupled between the other terminal of the capacitor C₁ and the ground voltage GND.

The switches SW₄ and SW₅ of the Y electrode driver 11 are coupled in series to both terminals of the capacitor C₁ of the Y electrode power supplier 13. The contact of the switches SW₄ and SW₅ is coupled to the panel capacitor Cₚ.

As shown in FIG. 2, when the switches SW₄ and SW₄′ are turned on, with the switches SW₁, SW₃, and SW₂, on and the switches SW₂, and SW₅ off, the Y electrode voltage V_{y} is increased to Vₛ and the capacitor C₁ is charged with the voltage Vₛ.

Subsequently, when the switch SW₅ is turned on, with the switch SW₄ off, the Y electrode voltage V_{y} is decreased to the ground voltage. When the switches SW₁, SW₃, and SW₄ are turned off and the switches SW₂ and SW₅ are turned on, the Y electrode voltage V_{y} is decreased to −Vₛ by the voltage Vₛ charged in the capacitor C₁. When the switch SW₅ is off and the switch SW₄ is on, the Y electrode voltage V_{y} is increased to the ground voltage 0V.

Through this driving operation, positive voltage +Vₛ and negative voltage −Vₛ can be alternately applied to the Y electrodes. Likewise, positive voltage +Vₛ and negative voltage −Vₛ can be alternately applied to the X electrodes. The voltages ±Vₛ respectively applied to the X and Y electrodes have an inverted phase with respect to each other. By generating a sustain pulse swinging between −Vₓ and +Vₛ, the potential difference between X and Y electrodes can be maintained at the sustain discharge voltage 2Vₛ.

Such a driver circuit can employ elements of a low withstand voltage, because the withstand voltage of each element in the circuit is Vₛ. However, this driver circuit is applicable only to plasma display panels using a pulse swinging between −Vₛ and +Vₛ.

In addition, the capacitor for storing the voltage used as a negative (−) voltage in this circuit must have a large capacity, so a considerable amount of an inrush current flows in an initial starting step due to the capacitor.

### SUMMARY OF THE INVENTION

This invention provides apparatus and methods for driving a PDP which prevent an inrush current flow in an initial starting step.

This invention separately provides apparatus and methods for driving a PDP which use switches having a low withstand voltage.

This invention separately provides apparatus and methods for driving a PDP where the withstand voltage of the switches can be half of the voltage 2Vs necessary for a sustain discharge, thereby at least reducing the production unit cost.

This invention separately provides apparatus and methods for driving a PDP which reduces, and preferably eliminates, an inrush current generated when the voltage stored in an external capacitor is used in changing the terminal voltage of the panel capacitor.

This invention separately provides apparatus and methods for driving a PDP which can be used irrespective of the waveform of sustain pulses by changing the power source applied to it.

This invention separately provides an apparatus for driving a plasma display panel that includes a first driving section and a first clamping section. The first driving section includes first and second switches that are coupled in series between a first power source for supplying a first voltage and one terminal of a panel capacitor, and third and fourth switches coupled in series between the one terminal of the panel capacitor and a second power source for supplying a second voltage.

In an exemplary embodiment of the apparatus and methods according to this invention, the first clamping section includes fifth and sixth switches that are coupled between a contact of the first and second switches and a contact of the third and fourth switches, and a contact of the fifth and sixth switches that are coupled to a third power source for supplying a third voltage.

The first clamping section, in various exemplary embodiments of this invention, further includes first and second capacitors that are coupled in series between the first and second power sources and a contact of the first and second capacitors being coupled to a contact of the fifth and sixth switches.

In a second exemplary embodiment of this invention, the first driving section alternately applies the first and second voltages to the one terminal of the panel capacitor by a driving operation of the first and second switches and the third and fourth switches, respectively. In this exemplary embodiment the first clamping section includes a first signal line that is coupled between a contact of the first and second switches and a third power source for supplying a third voltage while the one terminal of the panel capacitor is substantially fixed to the second voltage, and a second signal line that is coupled between a contact of the third and fourth switches and the third power source while the one terminal of the panel capacitor is substantially fixed to the first voltage.

Preferably, in various exemplary embodiments of the apparatus and methods according to this invention the first clamping section further includes fifth and sixth switches formed on the first and second signal lines, respectively, and each has a body diode. The fifth switch is turned on, with the first and second switches off and the third and fourth switches on. The sixth switch is turned on, with the first and second switches on and the third and fourth switches off.

The first signal line causes the withstand voltages of the first and second switches to be clamped to the difference between the first and third voltages and the difference between the third and second voltages, respectively. The second signal line causes the withstand voltages of the third and fourth switches to be clamped to the difference between the first and third voltages and the difference between the third and second voltages, respectively.

Preferably, the driving apparatus according to the present invention further includes a power recovery section including at least one inductor coupled to the one terminal of the panel capacitor. The power recovery section changes a terminal voltage of the panel capacitor using a resonance generated between the inductor and the panel capacitor.

The power recovery section stores energy in the inductor and changes the terminal voltage of the panel capacitor using the energy stored in the inductor and the resonance, while the one terminal of the panel capacitor is sustained at the first or second voltage.

This invention separately provides a method for driving a plasma display panel by coupling a third voltage between a plurality of first switches formed on a second signal line, while one terminal of a panel capacitor is fixed to a first voltage through a first signal line, and coupling the third voltage between a plurality of second switches formed on a first signal line, while the one terminal of the panel capacitor is fixed to the second voltage through a second signal line.

Preferably, the voltage of the one terminal of the panel capacitor is raised to the first voltage using a resonance generated between an inductor coupled to the one terminal of the panel capacitor and the panel capacitor. The voltage of the one terminal of the panel capacitor is dropped to the second voltage using a resonance generated between the inductor and the panel capacitor.

Prior to changing the voltage of the one terminal of the panel capacitor, energy is stored in the inductor through a path of the third voltage, the inductor and the second signal line, or a path of the first signal line, the inductor and the third voltage.

These and other features and advantages of this invention are described in, or are apparent from, the following detailed description of various exemplary embodiments of the apparatus and methods according to this invention.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of a known driver circuit;

FIG. 2 is a timing diagram showing a driving operation of the driver circuit according to the driver circuit illustrated in FIG. 1;

FIG. 3 is a schematic of a plasma display panel according to the present invention;

FIG. 4 is a circuit diagram showing a driver circuit of a plasma display panel according to a first exemplary embodiment of the present invention;

FIGS. 5a and 5b are illustrations showing a current path in each mode of the driver circuit according to the first exemplary embodiment of the present invention;

FIG. 6 is a timing diagram showing a driving operation of the driver circuits according to the first exemplary embodiment of the present invention;

FIG. 7 is a circuit diagram showing a driver circuit of a plasma display panel according to a second exemplary embodiment of the present invention;

FIGS. 8a to 8h are illustrations showing a current path in each mode of the driver circuit according to the second exemplary embodiment of the present invention; and

FIG. 9 is a timing diagram showing a driving operation of the driver circuits according to the second exemplary embodiment of the present invention.

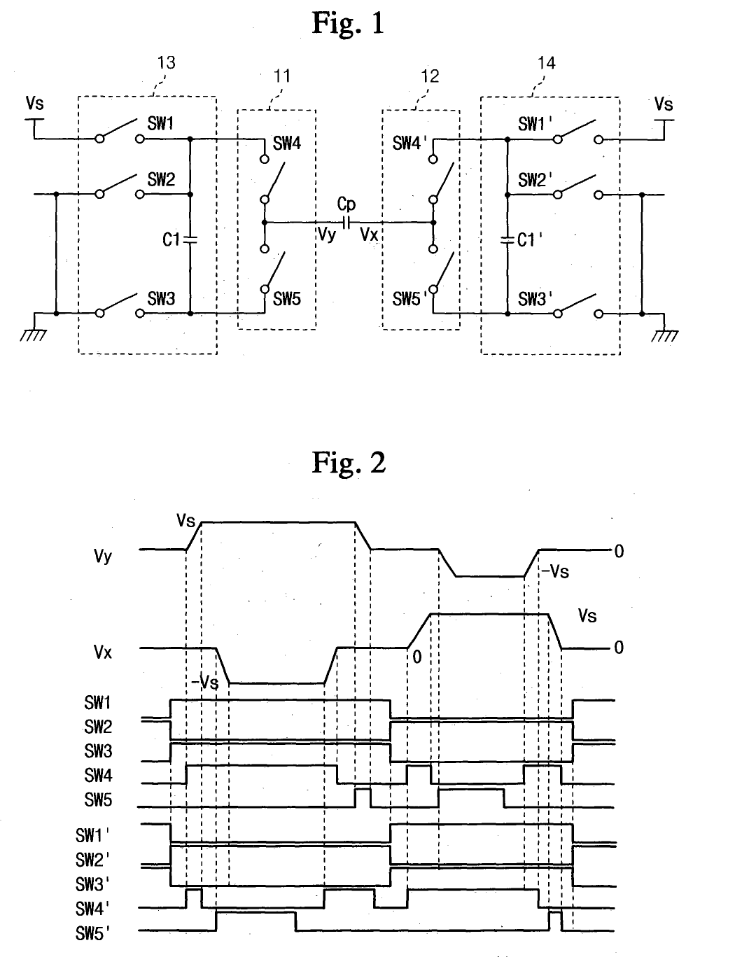

### DETAILED DESCRIPTION OF THE PREFERRED EMBODIMENTS

In the following detailed description, various exemplary embodiments of the invention have been shown and described, simply to illustrate a best mode contemplated by the inventors of carrying out the invention. As will be realized, the invention is capable of modification in various obvious respects, all without departing from the invention. Accordingly, the drawings and description are to be regarded as illustrative in nature, and not restrictive.

In the figures, some parts not related to the description are omitted for a better understanding of the present invention, and throughout the specification the same reference numeral is assigned to the same parts. The term “a part is coupled to another one” may include the case where the two parts are indirectly connected via, for example, a third element as well as the case where the two parts are directly connected together.

Hereinafter, a description will be given for an apparatus and method for driving an exemplary embodiment of a plasma display panel (PDP) according to this invention with reference to the accompanying drawings.

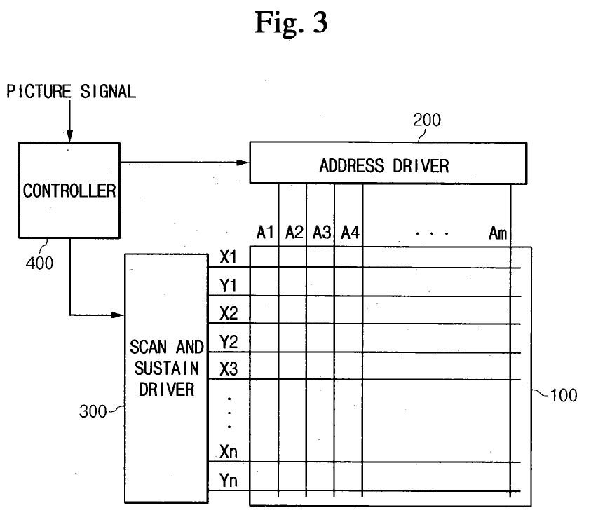

First, reference will be made to FIG. 3 to describe a schematic structure of an exemplary PDP according to this invention.

The PDP according to this exemplary embodiment of this invention comprises, as shown in FIG. 3, a plasma panel 100, an address driver 200, a scan/sustain driver 300, and a controller 400.

The plasma panel 100 comprises a plurality of address electrodes A₁ to Aₘ arranged in rows, and a plurality of scan electrodes (hereinafter referred to as “Y electrodes”) Y₁ to Yₙ and sustain electrodes (hereinafter referred to as “X electrodes”) X₁ to Xₙ alternately arranged in columns.

The address driver 200 receives an address drive control signal from the controller 400, and applies a display data signal for selection of discharge cells to be displayed to the individual address electrodes.

The scan/sustain driver 300 receives a sustain discharge signal from the controller 400, and applies a sustain discharge pulse alternately to the X and Y electrodes. The input sustain discharge pulse causes a sustain discharge on the selected discharge cells.

The controller 400 receives an external picture signal, generates the address drive control signal and the sustain discharge signal, and applies the address drive control signal and the sustain discharge signal to the address driver 200 and the scan/sustain driver 300, respectively.

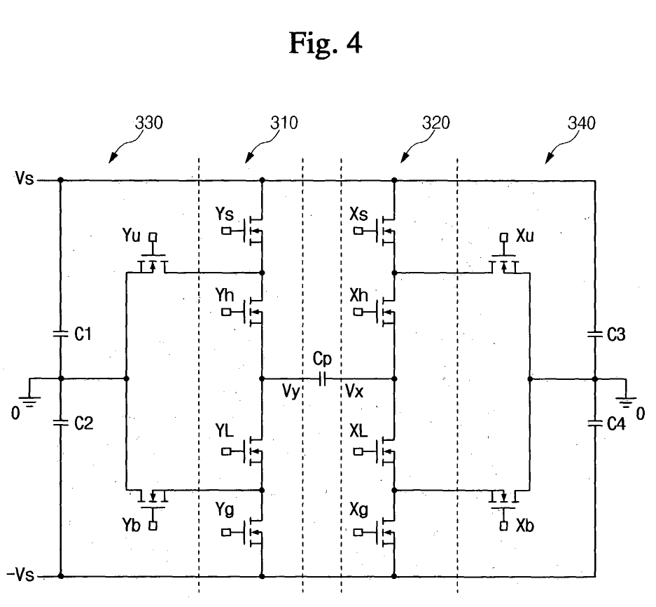

Below is a description of a driver circuit of the scan/sustain driver 300 according to a first exemplary embodiment of the present invention with reference to FIGS. 4 to 6.

The driver circuit according to the first exemplary embodiment of the present invention comprises, as shown in FIG. 4, a Y electrode driver 310, an X electrode driver 320, a Y electrode clamping section 330, and an X electrode clamping section 340.

The Y electrode driver 310 and the X electrode driver 320 are coupled to each other with a panel capacitor Cₚ therebetween. The Y electrode driver 310 comprises switches Yₛ and Yₕ which are coupled in series between a power source Vs and the Y electrodes of the panel capacitor Cₚ, and switches Y_{L} and Y_{g} coupled in series between the Y electrodes of the panel capacitor Cₚ and the power source −Vₛ.

Likewise, the X electrode driver 320 comprises switches Xₛ and Xₕ that are coupled in series between the power source Vs and the X electrodes of the panel capacitor Cₚ, and switches X_{L} and X_{g} coupled in series between the X electrodes of the panel capacitor Cₚ and the power source −Vs.

The Y clamping section 330 comprises switches Yᵤ and Y_{b}, which are coupled between a contact of each of the switches Yₛ and Yₕ and the ground terminal and between a contact of each of the switches Y_{L} and Y_{g} and the ground terminal, respectively. The Y clamping section 330 may further comprise capacitors C₁ and C₂ for storing the voltages of the power sources Vs and −Vs that realize the actual circuit, respectively.

Likewise, the X clamping section 340 comprises switches Xᵤ and X_{b}, which are coupled between a contact of each of the switches Xₛ and Xₕ and the ground terminal and between a contact of each of the switches X_{L} and X_{g} and the ground terminal, respectively. The X clamping section 340 may further comprise capacitors C₃ and C₄ for storing the voltages of the power sources Vs and −Vs that realize the actual circuit, respectively.

Although the switches Yₛ, Yₕ, Y_{L}, Y_{g}, Yᵤ, Y_{b}, Xₛ, Xₕ, X_{L}, X_{g}, Xᵤ, and Y_{b} which are included in the Y and X electrode drivers 310 and 320 and the Y and X clamping sections 330 and 340 are denoted as a MOSFET in FIG. 4, they are not specifically limited to MOSFETs, and may include any switches that perform the same or similar functions. Preferably, the switches have a body diode.

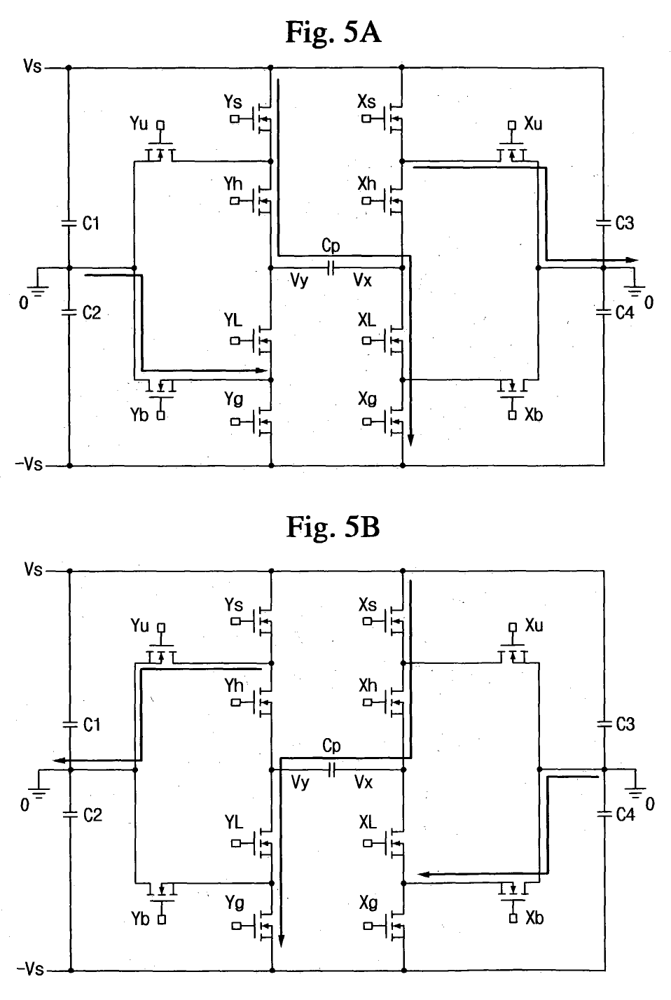

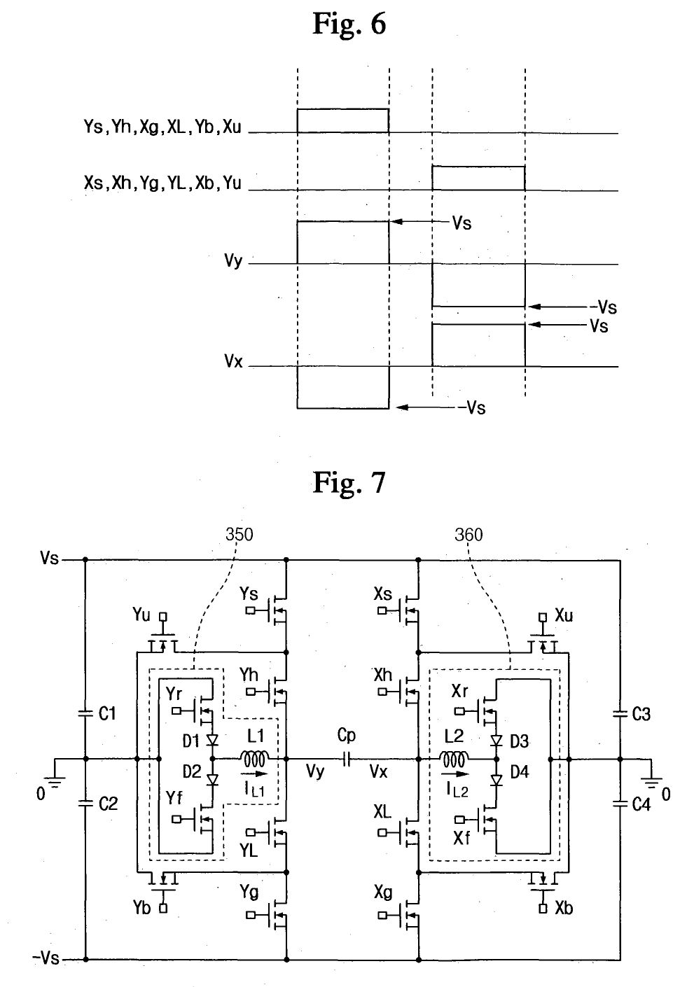

Below is a description of a driving method of the driver circuit according to the first exemplary embodiment of the apparatus and methods of this invention with reference to FIGS. 5a, 5b, and 6.

FIGS. 5a and 5b are illustrations showing a current path in each mode of the driver circuit according to the first exemplary embodiment of the apparatus and methods of this invention, and FIG. 6 is a timing diagram showing a driving operation of the driver circuits according to the first exemplary embodiment of this invention.

In the first exemplary embodiment of the apparatus and methods of this invention, it is assumed that the voltages supplied by the power sources Vs and −Vs are Vₛ and −Vₛ, respectively, and that the capacitors C₁, C₂, C₃, and C₄ are charged to the voltage Vₛ. It is also assumed that the voltage Vₛ is a half of the sustain discharge voltage 2Vₛ which is necessary for a sustain discharge of the panel.

First, the operation in mode 1 (M1) will be described with reference to FIGS. 5a and 6. In mode 1, the switches Yₛ, Yₕ, X_{g}, X_{L}, Y_{b}, and Xᵤ are turned on, with the switches Xₛ, Xₕ, Y_{g}, Y_{L}, X_{b}, and Yᵤ off.

The switches Yₛ and Yₕ in the on state cause the voltage Vₛ of the power source Vs to be applied to the Y electrodes of the panel capacitor Cₚ, and the switches X_{L} and X_{g} in the on state cause the voltage −Vₛ of the power source −Vs to be applied to the X electrodes of the panel capacitor Cₚ. The Y and X electrode voltages V_{y} and Vₓ of the panel capacitor Cₚ are Vₛ and −Vₛ, respectively, so that the voltage applied to both terminals of the panel capacitor is 2Vₛ. Generally, a voltage of 2Vₛ necessary for a sustain discharge to be applied.

When the switch Y_{b} is turned on, the voltage Vₛ stored in the capacitor C₁ is applied to both terminals of the switch Y_{L} via a loop of capacitor C₁, switches Yₛ, Yₕ, and Y_{L}, and the body diode of switch Y_{b} and the voltage Vₛ which is stored in the capacitor C₂ is applied to both terminals of the switch Y_{g} via a loop of capacitor C₂ and switches Y_{b} and Y_{g}.

When the switch Xᵤ is turned on, the voltage Vₛ stored in the capacitor C₃ is applied to both terminals of the switch Xₛ via a loop of capacitor C₃ and switches Xₛ and Xᵤ, and the voltage Vₛ stored in the capacitor C₄ is applied to both terminals of the switch Xₕ via a loop of capacitor C₄, the body diode of switch Xᵤ and switches Xₕ, X_{L}, and X_{g}.

Accordingly, the withstand voltages of the switches Y_{L}, Y_{g}, Xₛ, and Xₕ in the off state are clamped to Vₛ in mode 1.

Next, the operation in mode 2 (M2) will be described with reference to FIGS. 5b and 6. In mode 2, the switches Xₛ, Xₕ, Y_{g}, Y_{L}, X_{b}, and Yᵤ are turned on, with the switches Yₛ, Yₕ, X_{g}, X_{L}, Y_{b}, and Xᵤ off.

The switches Y_{g} and Y_{L} in the on state cause the voltage −Vₛ of the power source −Vs to be applied to the Y electrodes of the panel capacitor Cₚ, and the switches Xₛ and Xₕ in the on state cause the voltage Vₛ of the power source Vs to be applied to the X electrodes of the panel capacitor Cₚ. The Y and X electrode voltages V_{y} and Vₓ of the panel capacitor Cₚ are −Vₛ and Vₛ, respectively, so that the voltage applied to both terminals of the panel capacitor is −2Vₛ. Namely, a voltage of 2Vₛ necessary for a sustain discharge to be applied.

When the switch X_{b} is turned on, the voltage Vₛ stored in the capacitor C₃ is applied to both terminals of the switch X_{L} via a loop of capacitor C₃, switches Xₛ, Xₕ, and X_{L} and the body diode of switch X_{b}, and the voltage Vₛ stored in the capacitor C₄ is applied to both terminals of the switch X_{g} via a loop of capacitor C₄ and switches X_{b} and X_{g}.

When the switch ᵤ is turned on, the voltage Vₛ stored in the capacitor C₁ is applied to both terminals of the switch Yₛ via a loop of capacitor C₁ and switches Yₛ and Yᵤ, and the voltage Vₛ, which is stored in the capacitor C₂ is applied to both terminals of the switch Yₕ via a loop of capacitor Cₛ, the body diode of switch Yᵤ and switches Yₕ, Y_{L}, and Y_{g}.

Thus, the withstand voltages of the switches Yₛ, Yₕ, X_{L}, and X_{g} in the off state are clamped to Vₛ in mode 2.

According to the first embodiment of the present invention, the switches Yᵤ, Y_{b}, Xᵤ, and X_{b} are operated to clamp the voltage applied to the switches Yₛ, Yₕ, Y_{L}, Y_{g}, Xₛ, Xₕ, X_{L}, and X_{g} at Vₛ, so that switches having a low withstand voltage can be used for the switches Yₛ, Yₕ, Y_{L}, Y_{g}, Xₛ, Xₕ, X_{L}, and X_{g}. Furthermore, a high inrush current, such as the inrush current in the prior art is substantially avoided in the initial starting step because the capacitors C₁, C₂, C₃, and C₄ are not used for applying a negative (−) voltage to the Y or X electrodes of the panel capacitor Cₚ.

Because of the capacitance component of the panel capacitor Cₚ, a reactive power as well as the power for a discharge is required in applying a waveform for a sustain discharge. A circuit for recovering the reactive power and reusing it is called “power recovery circuit”. Below is a description of another embodiment having a power recovery circuit added to the driver circuit according to the first exemplary embodiment of the apparatus and methods according to this invention with reference to FIGS. 7 to 9.

The driver circuit according to the second exemplary embodiment of the apparatus and methods according to this invention further comprises, as shown in FIG. 7, Y and X electrode power recovery sections 350 and 360 in addition to the features of the driver circuit according to the first exemplary embodiment of the present invention.

The Y electrode power recovery section 350 comprises an inductor L₁ and switches Yᵣ and Y_{f}. The inductor L₁ has one terminal coupled to a contact of the switches Yₕ and Y_{L}, i.e., the Y electrodes of the panel capacitor Cₚ, and the switches Yᵣ and Y_{f} are coupled in parallel between the other terminal of the inductor L₁ and the ground terminal. The Y electrode power recovery section 350 further comprises diodes D₁ and D₂ coupled between the switch Yᵣ and the inductor L₁ and between the switch Y_{f} and the inductor L₁, respectively. The diodes D₁ and D₂ form a current path to the inductor L₁ and a current path from the inductor L₁.

The X electrode power recovery section 360 comprises an inductor L₂ and switches Xᵣ and X_{f}, and additionally includes diodes D₃ and D₄. The X electrode power recovery section 360 is the same in construction as the Y electrode power recovery section 350 and will not be described in detail. The switches Yᵣ, Y_{f}, Xᵣ, and X_{f} of the Y and X electrode power recovery sections 350 and 360 may comprise MOSFETs.

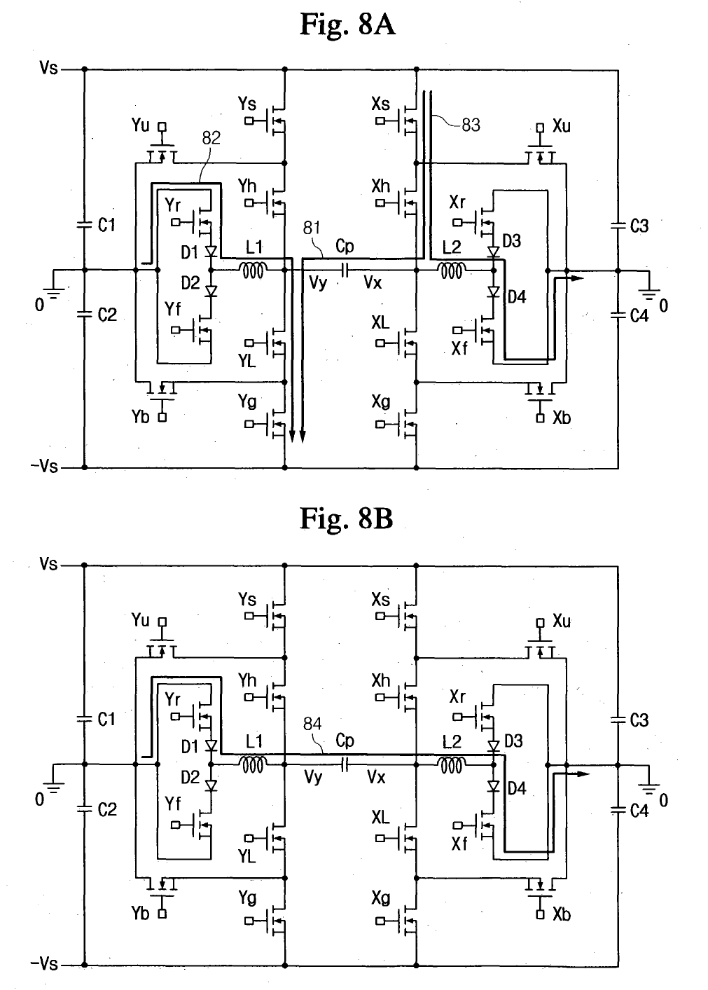

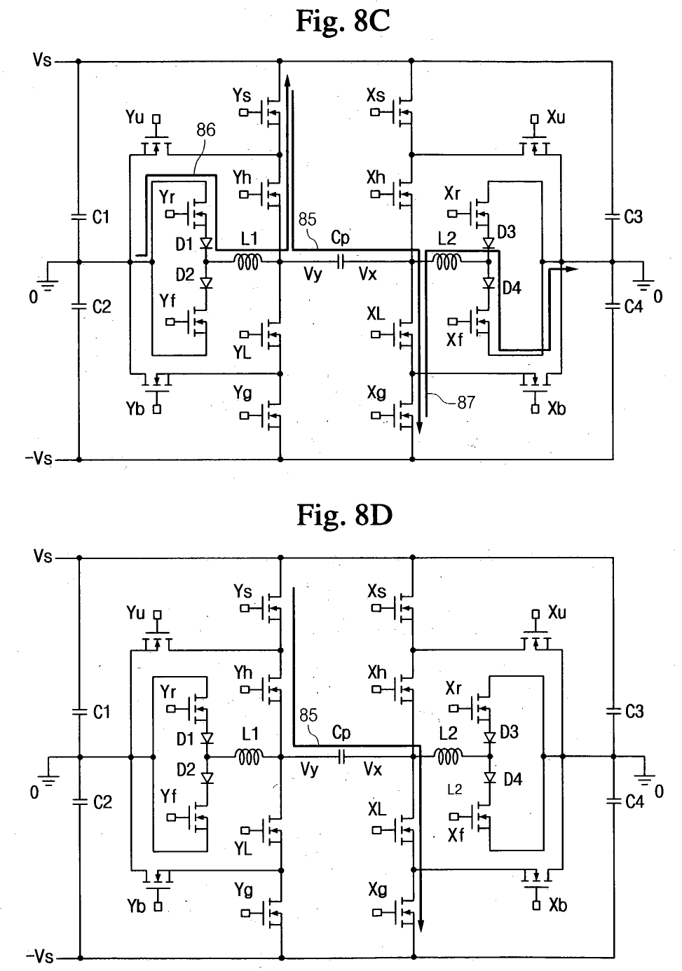

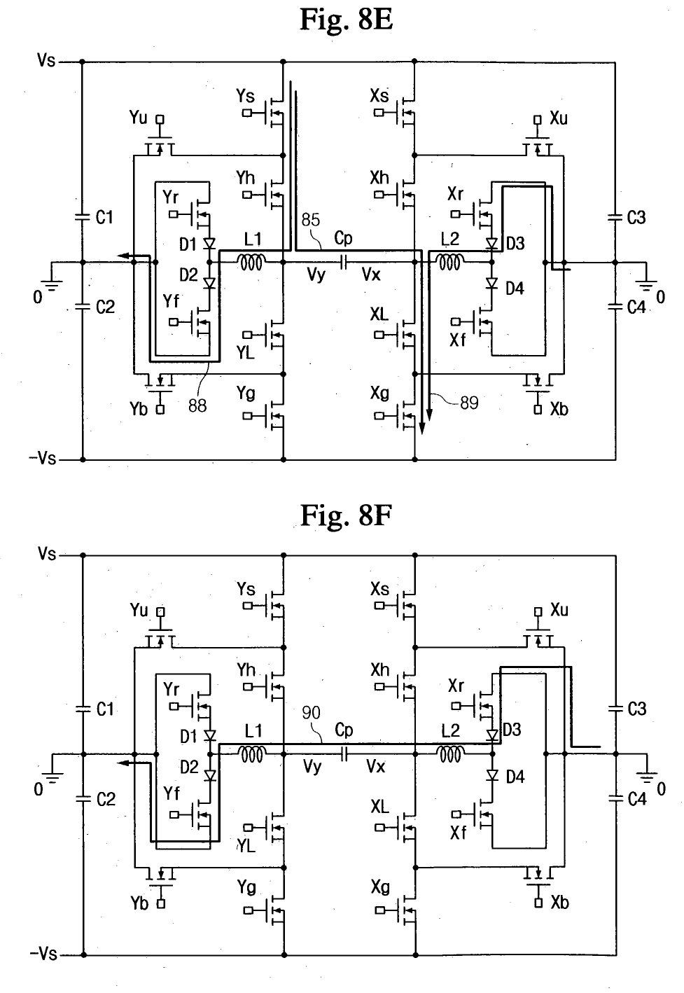

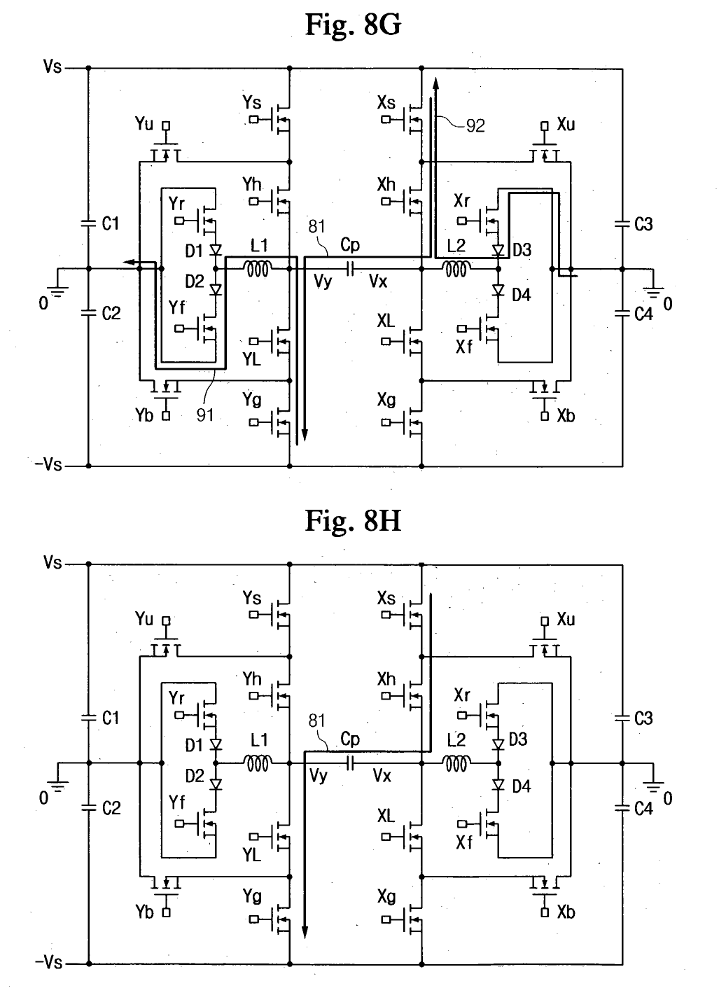

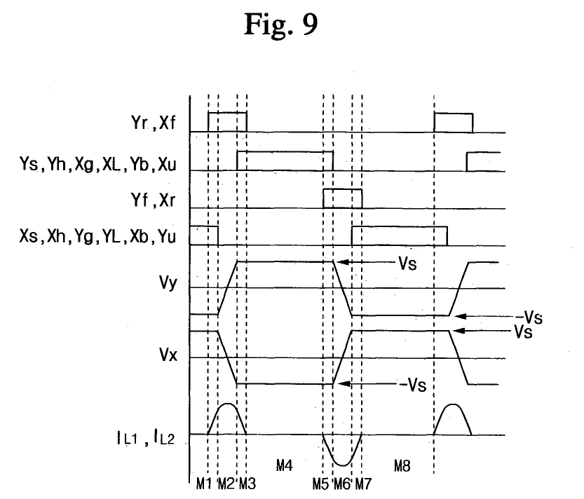

Below is a description of a driving method of the driver circuit according to the second exemplary embodiment of the apparatus and methods according to this invention with reference to FIGS. 8a to 8h and 9.

FIGS. 8a to 8h are illustrations showing a current path in each mode of the driver circuit according to the second exemplary embodiment of the apparatus and methods according to this invention, and FIG. 9 is a timing diagram showing a driving operation of the driver circuits according to the second exemplary embodiment of the apparatus and methods according to this invention.

In the second embodiment of the present invention, it is assumed that before the start of the mode 1, the switches Xₛ, Xₕ, Y_{g}, Y_{L}, X_{b}, and Yᵤ are in the on state, with the switches Yₛ, Yₕ, X_{g}, X_{L}, Y_{f}, X_{f}, Yᵣ, X_{f}, Y_{b}, and Xᵤ off. It is also assumed that the capacitors C₁, C₂, C₃, and C₄ are charged to a voltage of Vₛ and that the inductance of the inductors L₁ and L₂ is L.

(1) Mode 1 (M1)

Reference will be made to FIG. 8a and the M1 interval of FIG. 9 to describe the operation in mode 1.

Before the start of mode 1, a current path is formed that includes power source Vs, switches Xₛ and Xₕ, panel capacitor Cₚ, switches Y_{L} and Y_{g}, and power source −Vs. Then, the X electrode voltage Vₓ of the panel capacitor Cₚ is sustained at Vₛ due to the power source Vₛ, and the Y electrode voltage V_{y} of the panel capacitor Cₚ is sustained at −Vₛ due to the power source −Vs.

With the switch X_{b} in the on state, the withstand voltages of the switches X_{L} and X_{g} are clamped to Vₛ due to the voltage Vₛ stored in the capacitors C₃ and C₄, as described in the first embodiment. Likewise, with the switch Yᵤ in the on state, the withstand voltages of the switches, Yₛ and Yₕ are clamped to Vₛ due to the voltage Vs stored in the capacitors C₁ and C₂, as described in the first embodiment.

When the switches Yᵣ and X_{f} are turned on, current paths 82 and 83 are formed. Current path 82 includes the ground terminal, switch Yᵣ, diode D₁, inductor L₁, switches Y_{L} and Y_{g}, power source −Vs, and current path 83 includes power source Vs, switches Xₛ and Xₕ, inductor L₂, diode D₄, switch X_{f} and the ground terminal. Currents I_{L1} and I_{L2} flowing to the inductors L₁ and L₂ are linearly increased with a slope of Vₛ/L through the current paths 82 and 83. Due to the currents I_{L1} and I_{L2}, energy is stored in the inductors L₁ and L₂.

(2) Mode 2 (M2)

Reference will be made to FIG. 8b and the M2 interval of FIG. 9 to describe the operation in mode 2.

In mode 2, with the switches Yᵣ and X_{f} on, the switches Xₛ, Xₕ, Y_{g}, Y_{L}, X_{b}, and Yᵤ are turned off. Then, a current path 84 is formed that includes switch Yᵣ, diode D₁, inductor L₁, panel capacitor Cₚ, inductor L₂, diode D₄, and switch X_{f}, so that an LC resonance current flows due to the inductors L₁ and L₂ and the panel capacitor Cₚ. With this LC resonance current, the Y electrode voltage V_{y} of the panel capacitor Cₚ is increased to Vₛ and the X electrode voltage Vₓ is reduced to −Vₛ. The Y and X electrode voltages V_{y} and Vₓ do not exceed Vₛ and −Vₛ due to the body diodes of the switches Yₛ and Yₕ and the switches X_{L} and X_{g}, respectively.

As described above, energy is previously stored in the inductors L₁ and L₂, and the stored energy and the resonance current are used for changing the Y and X electrode voltages V_{y} and Vₓ of the panel capacitor Cₚ. Thus, the Y and X electrode voltages V_{y} and Vₓ can be changed to Vₛ and −Vₛ, respectively, even in the actual circuit including parasitic components.

(3) Mode 3 (M3)

Reference will be made to FIG. 8c and the M3 interval of FIG. 9 to describe the operation in mode 3.

In mode 3, with the switches Yᵣ and X_{f} on, the switches Yₛ, Yₕ, X_{g}, and X_{L} are turned on. Then, a current path 85 is formed that includes power source Vs, switches Yₛ and Yₕ, panel capacitor Cₚ, switches X_{L} and X_{g}, and power source −Vs. Due to the power sources Vs and −Vs, the Y and X electrode voltages V_{y} and Vₓ of the panel capacitor Cₚ are is sustained at Vₛ and −Vₛ, respectively.

The current I_{L1} flowing to the inductor L₁ is recovered to the power source Vs through a current path 86 that includes switch Yᵣ, diode D₁, inductor L₁, the body diode of switch Yₕ, and the body diode of switch Yₛ. The current I_{L2} flowing to the inductor L₂ is recovered to the ground terminal through a current path 87 that includes the body diode of switch X_{g}, the body diode of switch X_{L}, inductor L₂, diode D₄, and switch X_{f}.

When the switch Y_{b} is turned on, the withstand voltages of the switches Y_{L} and Y_{g} in the off state are clamped to Vₛ due to the voltage Vₛ stored in the capacitors C₁ and C₂, respectively. Likewise, when the switch Xᵤ is turned on, the withstand voltages of the switches Xₛ and Xₕ are clamped to Vₛ due to the voltage Vₛ stored in the capacitors C₃ and C₄, respectively.

(4) Mode 4 (M4)

Reference will be made to FIG. 8d and the M4 interval of FIG. 9 to describe the operation in mode 4.

In mode 4, with the switches Yₛ, Yₕ, X_{g}, X_{L}, Y_{b}, and Xᵤ on, the switches Yᵣ and X_{f} are turned off. By the current path 85 formed in Mode 3, the Y and X electrode voltages V_{y} and Vₓ of the panel capacitor Cₚ are still sustained at Vₛ and −Vₛ, respectively. And, the switches Y_{b} and Xᵤ in the on state cause the withstand voltages of the switches Xₛ, Xₕ, Y_{L}, and Y_{g} to be clamped to Vₛ.

(5) Mode 5 (M5)

Reference will be made to FIG. 8e and the M5 interval of FIG. 9 to describe the operation in mode 5.

In mode 5, with the switches Yₛ, Yₕ, X_{g}, X_{L}, Y_{b}, and Xᵤ on, the switches Y_{f} and Xᵣ are turned on. By the current path 85, the Y and X electrode voltages V_{y} and Vₓ of the panel capacitor Cₚ are still sustained at Vₛ and −Vₛ, respectively.

With the switches Y_{f} and Xᵣ on, a current path 88 is formed that includes power source Vs, switches Yₓ and Yₕ, inductor L₁, diode D₂, switch Y_{f}, and the ground terminal, and a current path 89 is formed that includes the ground terminal, switch Xᵣ, diode D₃, inductor L₂, switches X_{L} and X_{g}, and power source −Vs. By the current paths 88 and 89, the magnitude of currents I_{L1} and I_{L2} flowing to the inductors L₁ and L₂ are linearly increased with a slope of Vₛ/L (these currents are opposite in direction to those in mode 1 and are denoted as a negative (−) value in FIG. 9). Hence the energy is stored in the inductors L₁ and L₂.

The switches Y_{b} and Xᵤ in the on state cause withstand voltages of the switches Xₛ, Xₕ, Y_{L}, and Y_{g} to always be clamped to Vₛ.

(6) Mode 6 (M6)

Reference will be made to FIG. 8f and the M6 interval of FIG. 9 to describe the operation in mode 6.

In mode 6, with the switches Y_{f} and Xᵣ on, the switches Yₛ, Yₕ, X_{g}, X_{L}, Y_{b}, and Xᵤ are turned off. Then, a current path 90 is formed that includes switch Xᵣ, diode D₃, inductor L₂, panel capacitor Cₚ inductor L₁, diode D₂, and switch Y_{f}. The current path 90 makes an LC resonance current flow due to the inductors L₁ and L₂ and the panel capacitor Cₚ. With this LC resonance current, the Y electrode voltage V_{y} of the panel capacitor Cₚ, is decreased to −Vₓ and the X electrode voltage Vₓ is increased to Vₛ. The Y and X electrode voltages V_{y} and Vₓ do not exceed −Vₛ and Vₛ due to the body diodes of the switches Y_{L} and Y_{g} an d the switches Xₛ and Xₕ, respectively.

As described in mode 2, the energy stored in the inductors L₁ and L₂ is used, so that the Y and X electrode voltages V_{y} and Vₓ can be changed to −Vₛ and Vₛ, respectively, even in the actual circuit including parasitic components.

(7) Mode 7 (M7)

Reference will be made to FIG. 8g, and the M7 interval of FIG. 9 to describe the operation in mode 7.

In mode 7, with the switches Y_{f} and Xᵣ on, the switches Xₛ, Xₕ, Y_{g}, and Y_{L} are turned on. A current path 81 is then formed that includes power source Vs, switches Xₛ and Xₕ, panel capacitor Cₚ switches Y_{L} and Y_{g}, and power source −Vs. Due to the power sources Vs and −Vs, the Y and X electrode voltages V_{y} and Vₓ of the panel capacitor Cₚ are sustained at Vₛ and −Vₛ, respectively.

The current I_{L1} flowing to the inductor L₁ is recovered to the ground terminal through a current path 91 that includes the body diode of switch Y_{g}, the body diode of switch Y_{L}, inductor L₁, diode D₂, and switch Y_{f}. The current I_{L2} flowing to the inductor L₂ is recovered to the power source Vs through a current path 92 that includes switch Xᵣ, diode D₃, inductor L₂, the body diode of switch Xₕ and the body diode of switch Xₛ. Namely, the magnitude of currents I_{L1} and I_{L2} flowing to the inductors L₁ and L₂ are linearly decreased to zero with a slope of Vₛ/L.

As described above in regard to mode 1, the switches Yᵤ and X_{b} in the on state cause the withstand voltages of the switches Yₛ, Yₕ, X_{L}, and X_{g} to always be clamped to Vₛ.

(8) Mode 8 (M8)

Reference will be made to FIG. 8h and the M8 interval of FIG. 9 to describe the operation in mode 8.

In mode 8, with the switches Xₛ, Xₕ, Y_{g}, Y_{L}, X_{b}, and Yᵤ on, the switches Y_{f} and Xᵣ are turned off. By the current path 81 formed in mode 7, the Y and X electrode voltages V_{y} and Vₓ of the panel capacitor Cₚ are still sustained at −Vₓ and Vₛ, respectively. As described above in regard to mode 7, the switches Yᵤ and X_{b} in the on state cause the withstand voltages of the switches Yₛ, Yₕ, X_{L}, and X_{g} to always be clamped to Vₛ.

Subsequently, the cycle of modes 1 to 8 is repeated to generate Y and X electrode voltages V_{y} and Vₓ swinging between Vₛ and −Vₛ, thereby sustaining the potential difference between the X and Y electrodes at a sustain discharge voltage of 2Vₛ.

Although each of the Y and X electrode power recovery sections 350 and 360 has one inductor in the second embodiment of the present invention, all other differently modified power recovery sections may be used. For example, the Y electrode power recovery section 350 may include inductors L₁₁ and L₁₂ each forming a different path. More specifically, energy is stored in the inductor L₁₁ while the Y electrode voltage is sustained at Vₛ, and then used to change the Y electrode voltage to −Vₛ. The energy stored in the inductor L₁₁ is recovered and the energy is stored in the inductor L₁₂, while the Y electrode voltage sustained at −Vₛ. The energy stored in the inductor L₁₂ is used to change the Y electrode voltage to Vₛ.

In these embodiments of the present invention, it is assumed that the capacitors C₁, C₂, C₃, and C₄ are present in the driver circuit and the voltages stored in the capacitors are used for applying a withstand voltage to the switches. As described above, however, the capacitors C₁, C₂, C₃, and C₄ may not be included in the circuit, in which case the withstand voltage is applied to the switches by the power sources Vₛ and −Vₛ.

Although the voltages supplied by the power sources Vs and −Vs are Vₛ and −Vₛ, respectively, in the first and second embodiments of the present invention, a different voltage can also be used as long as the voltage difference between the two power sources is 2Vₛ, necessary for a sustain discharge. Namely, the voltages supplied by the power sources Vs and −Vs can be Vₕ and (Vₕ−2Vₛ) so that the Y and X electrode voltages V_{y} and Vₓ swing between Vₕ and (Vₕ−2Vₛ).

Although two switches are coupled between the power source and the X or Y electrode of the panel capacitor Cₚ in the first and second embodiments of the present invention, the number of switches is not specifically limited in the present invention. For example, when four switches S₁, S₂, S₃, and S₄ are coupled in series between the power source Vs and the Y electrode of the panel capacitor and the switch Yᵤ is coupled to the contact of the switches S₂ and S₃, the withstand voltage of the switches S₁ and S₂ or the switches S₃ and S₄ is Vₛ.

According to this invention, the withstand voltage of the switches can be half of the voltage 2Vₛ necessary for a sustain discharge, thereby reducing the production unit cost. The present invention also reduces, and preferably eliminates, an inrush current generated when the voltage stored in an external capacitor is used in changing the terminal voltage of the panel capacitor. Furthermore, the driver circuit of this invention can be used irrespective of the waveform of sustain pulses by changing the power source applied to it.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for driving a plasma display panel, which has a panel capacitor, the apparatus comprising:
a first driving section including first and second switches which are coupled in series between a first power source for supplying a first voltage and one terminal of the panel capacitor, and third and fourth switches which are coupled in series between the one terminal of the panel capacitor and a second power source for supplying a second voltage; and
a first clamping section including fifth and sixth switches coupled between a contact of the first and second switches and a contact of the third and fourth switches, a contact of the fifth switch and a contact of the sixth switch being coupled to a third power source for supplying a third voltage.

2. The apparatus for driving a plasma display panel according to claim 1, wherein the first clamping section further includes first and second capacitors coupled in series between the first and second power sources, wherein a contact of the first and second capacitors is coupled to a contact of the fifth switch and a contact of the sixth switch.

3. The apparatus for driving a plasma display panel according to claim 1, further comprising:
a power recovery section formed between the one terminal of the panel capacitor and the third power source, wherein the power recovery section and recovers a reactive power used in the panel capacitor.

4. The apparatus for driving a plasma display panel according to claim 3, wherein the power recovery section includes:
at least one inductor having one terminal thereof coupled to the one terminal of the panel capacitor; and
seventh and eighth switches coupled in parallel between the other terminal of the inductor and the third power source.

5. The apparatus for driving a plasma display panel according to claim 1, wherein each of the first, second, third, fourth, fifth and sixth switches has a body diode.

6. The apparatus for driving a plasma display panel according to claim 1, further comprising:
a second driving section including a seventh switch and an eighth switch which are coupled in series between the first power source and the other terminal of the panel capacitor, and a ninth switch and a tenth switch which are coupled in series between the other terminal of the panel capacitor and the second power source; and
a second clamping section including an eleventh switch and a twelfth switch which are coupled between a contact of each of the seventh and eighth switch and a contact of each of the ninth and tenth switches, a contact of the eleventh and twelfth switches being coupled to the third power source.

7. An apparatus for driving a plasma display panel, which has a panel capacitor, the apparatus comprising:
a first driving section including first and second switches coupled in series between a first power source for supplying a first voltage and one terminal of the panel capacitor, and third and fourth switches coupled in series between the one terminal of the panel capacitor and a second power source for supplying a second voltage, the first driving section alternately applying the first and second voltages to the one terminal of the panel capacitor by a driving operation of the first and second switches and the third and fourth switches, respectively; and
a first clamping section including a first signal line coupled between a contact of the first and second switches and a third power source for supplying a third voltage while the one terminal of the panel capacitor is substantially fixed to the second voltage, and a second signal line coupled between a contact of the third and fourth switches and the third power source while the one terminal of the panel capacitor is substantially fixed to the first voltage.

8. The apparatus for driving a plasma display panel according to in claim 7, wherein the first clamping section further includes a fifth switch and a sixth switch formed on the first and second signal lines, respectively, and each switch having a body diode.

9. The apparatus for driving a plasma display panel according to claim 8, wherein the fifth switch is turned on, with the first and second switches off and the third and fourth switches on; and
the sixth switch is turned on, with the first and second switches on and the third and fourth switches off.

10. The apparatus for driving a plasma display panel according to claim 7, wherein each of the first, second, third and fourth switches each has a body diode.

11. The apparatus for driving a plasma display panel according to claim 7, wherein the first signal line causes the withstand voltages of the first and second switches to be clamped to the difference between the first and third voltages and the difference between the third and second voltages, respectively, and
the second signal line causes the withstand voltages of the third and fourth switches to be clamped to the difference between the first and third voltages and the difference between the third and second voltages, respectively.

12. The apparatus for driving a plasma display panel according to claim 7, further comprising:
a second driving section including fifth and sixth switches coupled in series between the first power source and the one terminal of the panel capacitor, and seventh and eighth switches coupled in series between the one terminal of the panel capacitor and the second power source, the second driving section alternately applying the first and second voltages to the one terminal of the panel capacitor by a driving operation of the fifth and sixth switches and the seventh and eighth switches, respectively; and
a second clamping section including a third signal line coupled between a contact of the fifth and sixth switches and the third power source while the one terminal of the panel capacitor is substantially fixed to the second voltage, and a fourth signal line coupled between a contact of the seventh and eighth switches and the third power source while the one terminal of the panel capacitor is substantially fixed to the first voltage.

13. The apparatus for driving a plasma display panel according to claim 7, further comprising:
a power recovery section including at least one inductor coupled to the one terminal of the panel capacitor, the power recovery section changing a terminal voltage of the panel capacitor using a resonance generated between the inductor and the panel capacitor.

14. The apparatus as claimed in claim 13, wherein the power recovery section stores energy in the inductor and changes the terminal voltage of the panel capacitor using energy stored in the inductor and the resonance, while the one terminal of the panel capacitor is sustained at the first or second voltage.

15. A method for driving a plasma display panel, in which the plasma display panel is driven by alternately applying first and second voltages through first and second signal lines coupled to one terminal of a panel capacitor, the method comprising steps:
(a) coupling a third voltage between a plurality of first switches formed on the second signal line, while the one terminal of the panel capacitor is fixed to the first voltage through the first signal line; and
(b) coupling the third voltage between a plurality of second switches formed on the first signal line, while the one terminal of the panel capacitor is fixed to the second voltage through the second signal line.

16. The method as claimed in claim 15, wherein the step (a) includes coupling the third voltage to a contact of two of the first switches formed on the second signal line,
the step (b) including coupling the third voltage to a contact of two of the second switches formed on the first signal line.

17. The method as claimed in claim 15, wherein, the step (a) further includes raising the voltage of the one terminal of the panel capacitor to the first voltage using a resonance generated between an inductor coupled to the one terminal of the panel capacitor and the panel capacitor, and
the step (b) further includes dropping the voltage of the one terminal of the panel capacitor to the second voltage using a resonance generated between the inductor and the panel capacitor.

18. The method as claimed in claim 17, wherein the step (a) further includes storing energy in the inductor through a path of the third voltage, the inductor and the second signal line, and
the step (b) further includes storing energy in the inductor through a path of the first signal line, the inductor, and the third voltage.
